(19) United States
(12) Patent Application Publication
(10) Pub. No.: US 2025/0116295 A1
(43) Pub. Date: Apr. 10, 2025

(54) DEEP GROOVE BALL BEARING

(71) Applicant: Aktiebolaget SKF, Göteborg (SE)

(72) Inventors: Yachang JIA, Shanghai (CN); Hongyuan AN, Shanghai (CN); Liwei GAO, Kunshan (CN)

(21) Appl. No.: 18/901,136

(22) Filed: Sep. 30, 2024

(30) Foreign Application Priority Data
Oct. 7, 2023 (CN) 202311293760.1

(51) Int. Cl. F16C 19/06; F16C 33/66

(52) U.S. Cl. CPC F16C 19/06; F16C 33/6603

(57) ABSTRACT

A deep groove ball bearing has an outer ring, an inner ring, balls arranged between the outer ring and the inner ring, and a cage for holding the balls. A ratio of an outer ring raceway radius of the outer ring to the ball's diameter is 0.525˜0.570. Two edges of the outer ring raceway in the axial direction define an outer ring raceway limiting angle relative to the center of the arc of the outer ring raceway that is 66°˜97°. A ratio of an inner ring raceway radius of the inner ring to the ball's diameter is 0.510˜0.530. Two edges of the inner ring raceway in the axial direction define an inner ring raceway limiting angle relative to the center of the arc of the inner ring raceway that is 72°˜99°. Compared with the existing art, the deep groove ball bearing has significantly reduced friction torque.

### CROSS-REFERENCE TO RELATED APPLICATION

This application claims priority to Chinese Application No. 202311293760.1, filed Oct. 7, 2023, the entirety of which is hereby incorporated by reference.

### FIELD

The present disclosure relates to the field of mechanical equipment, in particular to a deep groove ball bearing.

### BACKGROUND

Bearings are used to support mechanical rotating bodies in mechanical equipment. A bearing changes the sliding friction between a rotation shaft and a shaft seat into rolling friction, thus reducing the friction loss.

Deep groove ball bearing is a type of bearing. A deep groove ball bearing generally include an outer ring, an inner ring, balls arranged between the outer ring and the inner ring, and a cage for holding the balls. The outer ring and the inner ring of the deep groove ball bearing have an outer ring raceway and an inner ring raceway respectively. When the bearing runs, the balls move in the space defined between the outer ring raceway and the inner ring raceway.

During the movement of the balls, there is interaction between the outer ring and the balls of the bearing and between the inner ring and the balls of the bearing, which interaction includes friction, so that the bearing still has a certain friction torque. In order to reduce friction, lubricating oil or grease can generally be used to lubricate the parts. However, there is still a need to improve the structures of the bearing parts to improve the existing lubrication effect.

### SUMMARY

In view of the above problems, according to a first aspect of the present disclosure, a deep groove ball bearing is proposed, which has an outer ring, an inner ring, balls arranged between the outer ring and the inner ring, and a cage for holding the balls, the outer ring has an outer ring raceway, the outer ring raceway defines an outer ring raceway radius, the ratio of the outer ring raceway radius to the diameter of the balls defines a first ratio, and two edges of the outer ring raceway in the axial direction define an outer ring raceway limiting angle relative to the center of the arc of the outer ring raceway, the inner ring has an inner ring raceway, the inner ring raceway defines an inner ring raceway radius, the ratio of the inner ring raceway radius to the diameter of the balls defines a second ratio, and two edges of the inner ring raceway in the axial direction define an inner ring raceway limiting angle relative to the center of the arc of the inner ring raceway, the range of the first ratio is 0.525˜0.570, the range of the second ratio is 0.510˜0.530, the range of the outer ring raceway limiting angle is 66°˜97°, and the range of the inner ring raceway limiting angle is 72°˜99°.

The applicant has found out that, in a deep groove ball bearing according to the present disclosure, by jointly controlling the respective raceway radii and raceway limiting angles of the outer ring and the inner ring, the friction torque of the bearing can be effectively reduced. In fact, according to results of the tests conducted by the applicant, the deep groove ball bearing of the present disclosure can greatly reduce the friction torque compared with the deep groove ball bearings of the existing art, as will be described in detail later.

In addition, due to the limitation of the respective raceway radii and raceway limiting angles of the outer ring and the inner ring in the present disclosure, the shoulder surfaces on both sides of the outer ring raceway of the deep groove ball bearing can be closer to the radial outer surface of the outer ring, and the shoulder surfaces on both sides of the inner ring raceway of the deep groove ball bearing can be closer to the radial inner surface of the inner ring. Therefore, the weight of the entire bearing can be reduced, which contributes to the lightweight of the equipment.

The deep groove ball bearing according to the present disclosure may have one or more of the following characteristics.

According to one embodiment, preferably, the range of the first ratio is 0.530˜0.565, the range of the second ratio is 0.515˜0.530, the range of the outer ring raceway limiting angle is 69°˜94°, and the range of the inner ring raceway limiting angle is 76°˜96°.

According to one embodiment, preferably, the range of the first ratio is 0.535˜0.560, the range of the second ratio is 0.520˜0.530, the range of the outer ring raceway limiting angle is 72°˜84°, and the range of the inner ring raceway limiting angle is 80°˜92°.

The above embodiments are preferred embodiments of the present disclosure, which leads to further reduced friction torque of the deep groove ball bearing.

According to one embodiment, preferably, the deep groove ball bearing includes lubricating grease. This embodiment enables the deep groove ball bearing to have further reduced friction torque with lubricating grease.

According to one embodiment, preferably, the viscosity of the lubricating grease is less than 40 mm²/s at 40° C.

According to one embodiment, preferably, the viscosity of the lubricating grease is less than 30 mm²/s at 40° C. The above embodiments enable the deep groove ball bearing to have further reduced friction torque.

According to one embodiment, preferably, the cage is made of a polymer. The deep groove ball bearing according to this embodiment has lighter weight, which contributes to the lightweight of the whole equipment.

According to one embodiment, preferably, the cage is a nylon plastic cage.

According to one embodiment, preferably, the cage includes a material capable of adsorbing lubricating oil or grease.

According to one embodiment, preferably, the cage is provided with an opening or pore for storing lubricating oil or grease. The deep groove ball bearing according to the above embodiments helps to keep an appropriate amount of lubricating oil or grease between the balls and the outer ring, the inner ring as well as the cage, improving the overall lubrication effect and reducing the friction torque.

### BRIEF DESCRIPTION OF THE DRAWINGS

In order to illustrate the technical solutions of the embodiments of the present disclosure more clearly, the accompanying drawings of the embodiments of the present disclosure will be briefly introduced hereinafter. The accompanying drawings are only used to illustrate some embodiments of the present disclosure, but not to limit all the embodiments of the present disclosure thereto.

FIG. 1 is a sectional perspective view of an embodiment of a deep groove ball bearing according to the present disclosure.

FIG. 2 is a schematic radial sectional view of the embodiment of the deep groove ball bearing according to the present disclosure.

FIG. 3 is another schematic radial sectional view of the embodiment of the deep groove ball bearing according to the present disclosure.

FIG. 4 is a part of a schematic sectional view of the embodiment of the deep groove ball bearing according to the present disclosure, which sectional plane is the central plane of the deep groove ball bearing orthogonal to the axial direction.

FIGS. 5A-5C are radial sectional views of various embodiments of the deep groove ball bearing according to the present disclosure.

### LIST OF REFERENCE NUMERALS

1 outer ring
10 outer ring raceway
11 first shoulder of outer ring
12 second shoulder of outer ring
13 first edge of outer ring raceway
14 second edge of outer ring raceway
15 center of the arc of outer ring raceway
2 inner ring
20 inner ring raceway
21 first shoulder of inner ring
22 second shoulder of inner ring
23 first edge of inner ring raceway
24 second edge of inner ring raceway
25 center of the arc of inner ring raceway
3 balls
30 ball center
4 cage
5 lubricating grease
6 seal

### DETAILED DESCRIPTION

In order to make the purpose, technical solution and advantages of the technical solutions of the present disclosure clearer, the technical solutions of the embodiments of the present disclosure will be clearly and completely described below with reference to the drawings of specific embodiments of the present disclosure. In the drawings, the same reference numerals represent the same parts. It should be noted that the described embodiments are part of the embodiments of the present disclosure, but not all of them. Based on the described embodiments of the present disclosure, all other embodiments obtained by those of ordinary skills in the art without creative labor are within the protection scope of the present disclosure.

Unless otherwise defined, the technical terms or scientific terms used here shall have their ordinary meanings as understood by those with ordinary skills in the field to which this present disclosure belongs. The words “first”, “second” and the like used in the description and claims of the patent application of the present disclosure do not indicate any order, quantity or importance, but are only used to distinguish different components. Similarly, words “a” or “an” and the like do not necessarily mean quantity limitation. Words “comprising” or “including” and the like mean that the elements or objects appearing before the word cover the listed elements or objects appearing after the word and their equivalents, without excluding other elements or objects. “Up”, “down”, “left” and “right” are only used to express relative positional relationship. When the absolute position of the described object changes, the relative positional relationship may also change accordingly.

The present disclosure will be described in detail below by describing example embodiments.

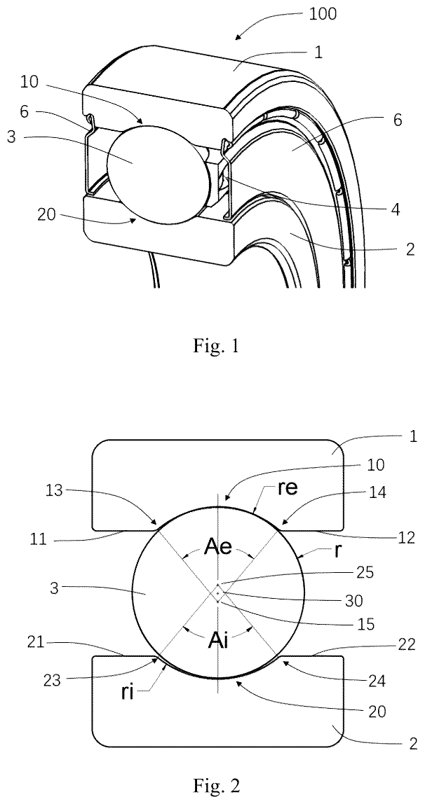

FIG. 1 shows a perspective view of one embodiment of a deep groove ball bearing 100 according to the present disclosure. As shown in FIG. 1, the deep groove ball bearing 100 has an outer ring 1, an inner ring 2, balls 3 arranged between the outer ring 1 and the inner ring 2, and a cage 4 for holding the balls 3. Although not shown in FIG. 1, the deep groove ball bearing 100 shown in FIG. 1 has a set of balls 3 between its outer ring 1 and inner ring 2 for the operation of the deep groove ball bearing 100. In addition, the deep groove ball bearing 100 shown in FIG. 1 further has two annular seals 6 arranged on both sides of the balls 3 in the axial direction to prevent dust from entering between the outer ring 1 and the inner ring 2. However, according to other embodiments of the present disclosure, seals of the deep groove ball bearing may be set to prevent lubricating oil or grease between the outer ring 1 and the inner ring 2 from flowing out, or the deep groove ball bearing may be provided with no seal.

Further, as shown in FIG. 1, the outer ring 1 has an outer ring raceway 10 and the inner ring 2 has an inner ring raceway 20. The outer ring raceway 10 and the inner ring raceway 20 respectively accommodate a part of each ball 3, so that the balls 3 can roll relative to the outer ring 1 and the inner ring 2 in the annular space formed by the outer ring raceway 10 and the inner ring raceway 20.

As shown in FIG. 2, the outer ring raceway 10 has an arc shape in the radial section of the deep groove ball bearing 100, and radius re of this arc is the outer ring raceway radius re. The inner ring raceway 20 has an arc shape in the radial section of the deep groove ball bearing 100, and radius ri of this arc is the inner ring raceway radius ri. FIG. 2 also shows the center 30 of a ball 3 and the radius r of the ball 3. The ratio of the outer ring raceway radius re to the diameter 2r of the ball 3 defines a first ratio fe=re/2r, and the ratio of the inner ring raceway radius ri to the diameter 2r of the ball 3 defines a second ratio fi=ri/2r. According to one embodiment of the deep groove ball bearing 100 of the present disclosure, the range of the first ratio fe is 0.525˜0.570 and the range of the second ratio fi is 0.510˜0.530. That is, the outer ring raceway radius re and the inner ring raceway radius ri are both slightly larger than the radius r of the ball 3. Thus, as shown in FIG. 2, the center 15 of the arc of the outer ring raceway 10 is farther away from the outer ring raceway 10 than the center 30 of the ball 3, and the center 25 of the arc of the inner ring raceway 20 is farther away from the inner ring raceway 20 than the center 30 of the ball 3.

In addition, as shown in FIG. 2, the outer ring raceway 10 has two annular edges, namely a first edge 13 and a second edge 14. The first edge 13 and the second edge 14 are respectively annular edges at both ends of the outer ring raceway 10 in the axial direction of the bearing. The inner ring raceway 20 has two annular edges, namely a first edge 23 and a second edge 24. The first edge 23 and the second edge 24 are respectively annular edges at both ends of the inner ring raceway 20 in the axial direction of the bearing. The first edge 13 and the second edge 14 of the outer ring raceway 10 define an outer ring raceway limiting angle Ae with respect to the center 15 of the arc of the outer ring raceway 10, and the first edge 23 and the second edge 24 of the inner ring raceway 20 define an inner ring raceway limiting angle Ai with respect to the center 25 of the arc of the inner ring raceway 20. In addition, in this embodiment of deep groove ball bearing 100, the range of the outer ring raceway limiting angle Ae is 66°˜97°, and the range of the inner ring raceway limiting angle Ai is 72°˜99°.

In the deep groove ball bearing 100 according to the present disclosure, by limiting the first ratio fe, the second ratio fi, the outer ring raceway limiting angle Ae and the inner ring raceway limiting angle Ai within the above-mentioned combination of ranges, the friction torque of the bearing can be effectively reduced.

Furthermore, according to a first preferred embodiment of the present disclosure, the range of the first ratio fe is 0.530˜0.565, the range of the second ratio fi is 0.515˜0.530, the range of the outer ring raceway limiting angle Ae is 69°˜94°, and the range of the inner ring raceway limiting angle Ai is 76°˜96°.

According to a second preferred embodiment of the present disclosure, the range of the first ratio fe is 0.535˜0.560, the range of the second ratio fi is 0.520˜0.530, the range of the outer ring raceway limiting angle Ae is 72°˜84°, and the range of the inner ring raceway limiting angle Ai is 80°˜92°.

According to a third preferred embodiment of the present disclosure, the deep groove ball bearing includes lubricating grease.

According to a fourth preferred embodiment of the present disclosure, the viscosity of the lubricating grease at 40° C. is less than 40 mm²/s.

According to a fifth preferred embodiment of the present disclosure, the viscosity of the lubricating grease at 40° C. is less than 30 mm²/s.

In tests conducted for deep groove ball bearings with the above geometries, these deep groove ball bearings show the ability to significantly reduce the friction torque. In the tests, the respective internal geometries of these deep groove ball bearings conform to the above-mentioned combinations of ranges, and the respective external geometries conform to the applicant's 6208-2Z/C3 model bearing. These deep groove ball bearings are each provided with a nylon plastic cage and are filled with lubricating grease with viscosity less than 40 mm²/s at 40° C. During the tests, the rotational speed of the bearings is 3600 rpm, the load includes general radial load and axial pre-load, and the ratio of the basic rated dynamic load C to the equivalent dynamic load P of bearing is C/P=20.

In addition, the applicant measured the friction torque of existing 6208-2Z/C3 deep groove ball bearings under the same conditions as a comparison. For such deep groove ball bearings, fe=0.523˜0.530, fi=0.508˜0.515, Ae=98°˜102°, Ai=100°˜105°. The existing deep groove ball bearings used in the comparative tests are also equipped with a nylon plastic cage and are filled with the same type of lubricating grease, and the same load setting is adopted in the comparative experiments.

The test results show that the friction torque of the deep groove ball bearing according to the present disclosure is significantly lower than the friction torque of the existing deep groove ball bearing measured in the comparative experiments, the friction torque of the deep groove ball bearings according to the first preferred embodiment of the present disclosure is further reduced, and the friction torque of the deep groove ball bearings according to the second preferred embodiment of the present disclosure is lower. Especially, the test results show that the friction torque of the deep groove ball bearing according to a preferred embodiment of the present disclosure can be reduced by 70% compared with that of the existing deep groove ball bearings.

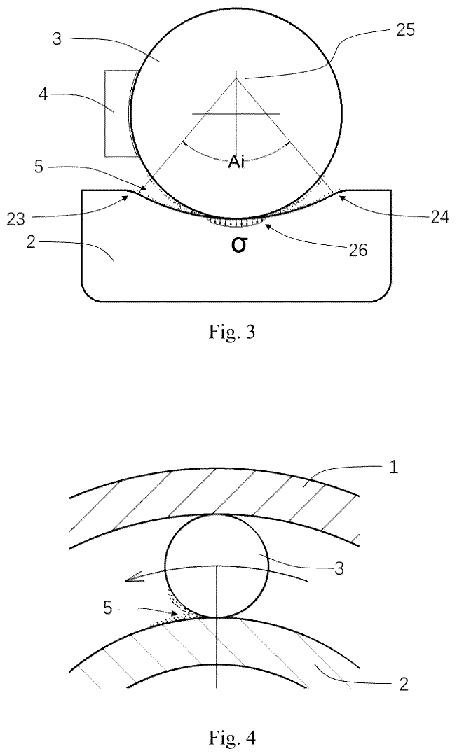

FIG. 3 shows another schematic radial sectional view of the embodiment of the deep groove ball bearing 100 according to the present disclosure, so as to help explain the advantages of the deep groove ball bearing according to the present disclosure. Only a part of the balls 3 and the inner ring 2 are shown in FIG. 3, so that the interaction between the balls 3 and the inner ring 2 and between the balls 3 and the outer ring 1 are described by taking the inner ring 2 as an example. For clarity, in FIG. 3, the radius ri of the inner ring raceway 20 is exaggerated to show the first edge 23 and the second edge 24 of the inner ring raceway 20 more clearly.

The friction torque of the deep groove ball bearing in operation comes from the friction force subjected to by the outer ring or inner ring of the bearing. The friction force is influenced by many factors, and there are also interactions among these factors. In the existing art, there are studies on influence of the ratio fe and fi of the raceway to the ball diameter on reducing the friction torque, but there is no public research project or research result on the influence of the coupling of fe and fi with Ae and Ai on the friction torque.

In the deep groove ball bearing of the present application, on the other hand, by jointly controlling the respective ranges of the first ratio fe, the second ratio fi, the outer ring raceway limiting angle Ae and the inner ring raceway limiting angle Ai, the friction torque of the bearing can be significantly reduced. The possible reasons obtained from the applicant's analysis are provided as below.

As shown in FIG. 3, during the operation of the bearing, the respective surfaces of the ball 3 and the inner ring raceway 20 press against each other, thus forming a contact area 26. In the contact area 26, the ball 3 exerts a compressive stress o on the inner ring 2 in the radial direction of the bearing, and in the contact area 26, both the ball 3 and the inner ring raceway 20 are elastically deformed. Such elastic deformation is constantly generated and relieved during the rolling process of the ball 3, which produces elastic resistance to the relative movement between the ball 3 and the inner ring 2, and this elastic resistance becomes a part of the friction force subjected to by the bearing.

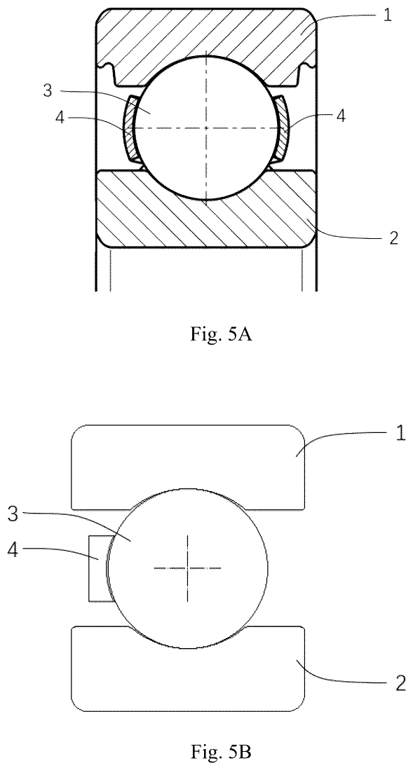

In another aspect, as shown in FIGS. 3 and 4, lubricating grease 5 exists in the gap space between the surface of ball 3 and the surface of the inner ring raceway 20. Lubricating grease 5 plays a lubricating role during the relative movement between the ball 3 and the inner ring raceway 20, especially in the contact area 26. Meanwhile, as the ball 3 rolls relative to the inner ring raceway 20, it will squeeze out the lubricating grease 5 in the gap space in front of the contact area 26 (see FIG. 4), so the movement of the lubricating grease 5 also produces resistance to the rolling of the ball 3, and as a result, another part of the friction force subjected to by the bearing is generated.

Therefore, on the basis of reducing the contact area between the ball 3 and the raceway surface by increasing the respective radii re and ri of the outer ring raceway 10 and the inner ring raceway 20, which thus reduces friction force, by appropriately reducing the arc length of the outer ring raceway 10 and the inner ring raceway 20 in the radial section of the bearing, for example, by controlling the outer ring raceway limiting angle Ae and the inner ring raceway limiting angle Ai, the dynamic process of the lubricating grease 5 being displaced by the ball 3 may be affected, which may lead to the reduction of the friction force. In addition, the respective radii of the outer ring raceway 10 and the inner ring raceway 20 contributes to the shape of the gap spaces between the ball 3 and the respective surfaces of the two raceways, so the respective radii of the outer ring raceway 10 and the inner ring raceway 20 will also affect the dynamic process of the lubricating grease 5 being displaced by the ball 3, thereby reducing the friction force.

In other words, the first ratio fe, the second ratio fi, the outer ring raceway limiting angle Ae and the inner ring raceway limiting angle Ai all affect the friction torque of the bearing in various ways, and the specific shape of the deep groove ball bearing found by the applicant according to the present disclosure can significantly reduce the friction torque. In addition, the applicant found that when lubricating grease is used in the deep groove ball bearing according to the present disclosure, especially lubricating grease with a viscosity less than 40 mm²/s at 40° C., a friction torque significantly reduced compared with that of the deep groove ball bearing of existing art can be obtained, and this optimized effect may also be related to the specific combinations of ranges of fe, fi, Ae and Ai.

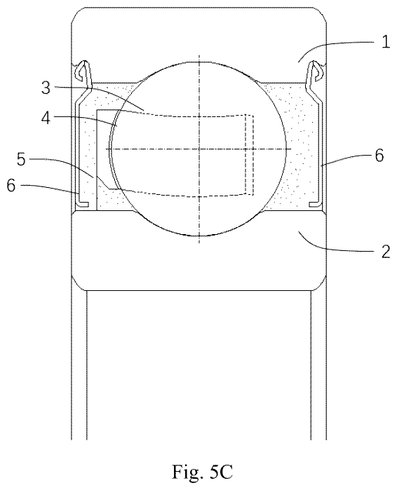

FIGS. 5A to 5C show other embodiments according to the present disclosure. In the deep groove ball bearing shown in FIG. 5A, the cage 4 is a steel cage. In the deep groove ball bearing shown in FIG. 5B, the cage 4 is a nylon plastic cage. According to other embodiments of the present disclosure, the cage 4 may also be made of other materials, such as a polymer material. Furthermore, in an embodiment according to the present disclosure not shown, the cage of the bearing may be provided with an opening or pore for storing lubricating oil or grease, or the cage of the bearing may include a material capable of adsorbing lubricating oil or grease, the material is for example phenolic resin. Therefore, an appropriate amount of lubricating oil or grease can be kept on the outer surface of the ball through the cage, thus ensuring the lubrication effect and reducing the friction torque of the deep groove ball bearing.

In the deep groove ball bearing shown in FIG. 5C, the cage 4 is a nylon plastic cage, and the deep groove ball bearing also has a sealing ring 6 for sealing lubricating grease 5. The lubricating grease 5 is filled between the outer ring 1 and the inner ring 2. In addition, the deep groove ball bearing of FIG. 5C also conforms to the combinations of ranges of the ratios fe and fi as well as the limiting angles Ae and Ai for the deep groove ball bearing according to the present disclosure, and it also has significantly reduced friction torque.

Exemplary embodiments of the bearing cage and the bearing proposed by the present disclosure have been described in detail above with reference to the preferred embodiments. However, it can be understood by those skilled in the art that various variations and modifications can be made to the above specific embodiments without departing from the concept of the present disclosure, and various technical features and structures proposed by the present disclosure can be combined in various ways without exceeding the protection scope of the present disclosure.

What is claimed is:

1. A deep groove ball bearing comprising:
an outer ring having an outer ring raceway, the outer ring raceway defines an outer ring raceway radius, two edges of the outer ring raceway in an axial direction defining an outer ring raceway limiting angle relative to a center of an arc of the outer ring raceway, a range of the outer ring raceway limiting angle being 66°˜97°;
an inner ring having an inner ring raceway, the inner ring raceway defines an inner ring raceway radius, two edges of the inner ring raceway in the axial direction defining an inner ring raceway limiting angle relative to a center of an arc of the inner ring raceway, a range of the inner ring raceway limiting angle being 72°˜99°;
a plurality of balls arranged between the outer ring and the inner ring; and
a cage for holding the balls, wherein a ratio of the outer ring raceway radius to a diameter of the balls defines a first ratio, a range of the first ratio being 0.525˜0.570; and
wherein a ratio of the inner ring raceway radius to the diameter of the balls defines a second ratio, a range of the second ratio being 0.510˜0.530.

2. The deep groove ball bearing according to claim 1, wherein the range of the first ratio is 0.530˜0.565, the range of the second ratio is 0.515˜0.530, the range of the outer ring raceway limiting angle is 69°˜94°, and the range of the inner ring raceway limiting angle is 76°˜96°.

3. The deep groove ball bearing according to claim 2, wherein the range of the first ratio is 0.535˜0.560, the range of the second ratio is 0.520˜0.530, the range of the outer ring raceway limiting angle is 72°˜84°, and the range of the inner ring raceway limiting angle is 80°˜92°.

4. The deep groove ball bearing according to claim 1, wherein the deep groove ball bearing comprises lubricating grease.

5. The deep groove ball bearing according to claim 4, wherein the viscosity of the lubricating grease is less than 40 mm²/s at 40° C.

6. The deep groove ball bearing according to claim 5, wherein the viscosity of the lubricating grease is less than 30 mm²/s at 40° C.

7. The deep groove ball bearing according to claim 1, wherein the cage is made of a polymer.

8. The deep groove ball bearing according to claim 7, wherein the cage is a nylon plastic cage.

9. The deep groove ball bearing according to claim 7, wherein the cage comprises a material capable of adsorbing lubricating oil or grease.

10. The deep groove ball bearing according to claim 1, wherein the cage is provided with an opening or pore for storing lubricating oil or grease.

11. The deep groove ball bearing according to claim 3, wherein the deep groove ball bearing comprises lubricating grease.

12. The deep groove ball bearing according to claim 11, wherein the viscosity of the lubricating grease is less than 40 mm²/s at 40° C.

13. The deep groove ball bearing according to claim 12, wherein the viscosity of the lubricating grease is less than 30 mm²/s at 40° C.

14. The deep groove ball bearing according to claim 3, wherein the cage is made of a polymer.

15. The deep groove ball bearing according to claim 14, wherein the cage is a nylon plastic cage.

16. The deep groove ball bearing according to claim 14, wherein the cage comprises a material capable of adsorbing lubricating oil or grease.

17. The deep groove ball bearing according to claim 3, wherein the cage is provided with an opening or pore for storing lubricating oil or grease.
